(19) United States
(12) Patent Application Publication
(10) Pub. No.: US 2007/0239781 A1
(43) Pub. Date: Oct. 11, 2007

(54) Electronic device and method therefor

(76) Inventors: Christian Kraft, Frederiksberg C (DK); Peter Dam Nielsen, Lyngby (DK)

Correspondence Address: PERMAN & GREEN, 425 POST ROAD, FAIRFIELD, CT, 06824, US

(21) Appl. No.: 11/402,279

(22) Filed: Apr. 11, 2006

(51) Int. Cl. G06F 7/00

(52) U.S. Cl. 707/104.1

(57) ABSTRACT

An electronic device including a user communication interface; a memory for storing music tracks and information about each of the stored music tracks, a music player capable of playing back the music tracks, and a processor. The information includes titles of the music tracks and names of artists or music groups on the music tracks, and the processor is provided for creating a list of favorite artists or music groups and playing back music tracks stored in the memory, one after the other, in response to a request from a user of the device via the user communication interface, wherein the played back music tracks are performed by one, several or all of the favorite artists or music groups in the list of favorite artists or music groups.

### FIELD

The aspects of the invention relate to an electronic device comprising a music player capable of playing back music tracks, and to a method therein.

### BACKGROUND

The portable music player market is growing every year, and music players and radio tuners have become available in many hand-portable telephones.

Users tend to store more and more music tracks in their devices and the need for better management of these music tracks is becoming increasingly important.

Many portable music players offer the possibility to define play lists, to assign different ratings to the music tracks, etc., but such preferences may be cumbersome to implement in hand-portable telephones due to these device's small displays and keypads. Hence, there is a need for automatically assisting the user in managing the music tracks stored in his/her device.

### SUMMARY

In one aspect, an electronic device is provided comprising a music player capable of playing back music tracks, which provides for a sophisticated manner of managing music tracks stored in a memory of the device and/or played back on the music player.

In a device is provided, by which a user can be informed automatically of his/her favorite music tracks and/or of his/her favorite artists or artist groups.

In another aspect, a device is provided by which the user may more proactively listen to his/her favorite music only.

In a further aspect a device is provided which further comprises a radio tuner, by which device the user may automatically swap back and forth from radio listening to local music playing depending on the user's favorite preferences.

In yet a further aspect, a device is provided, which is flexible, fast, efficient, user-friendly, and of reasonable cost.

In yet a further aspect a device is provided by which favorite music tracks are easier found and played.

According to a first aspect of the invention there is provided an electronic device and a method for playing back music tracks. A list of favorite artists or music groups is created, and music tracks stored in the memory are played back one after the other in response to a request from a user of the device via the user communication interface, wherein the played back music tracks are performed by one, several or all of the favorite artists or music groups in the list of favorite artists or music groups.

Hence, an entirely novel method for music listening is provided. The list of favorite artists or music groups are displayed to the user, from which list the user can choose to listen to a specified one or several, or all, of the music tracks of a desired one or several, or all, of favorite artists or music groups comprised in the list. The list of favorite artists may comprise functionality for searching for music tracks of the artists or music groups comprised in the list, and for creating play lists of music tracks of these artists or music groups.

The list of favorite artists or music groups may be created manually by a user of the device 11, semi-automatically, or entirely automatically, e.g. based on logged information regarding artists or music groups of music tracks that have been played back on the music player.

According to a second aspect of the invention there is provided an electronic device and a method for automatically logging information and for automatically creating a play list or a list of favorite artists or music groups. Information about music tracks that have been received by a radio tuner of the device and music tracks that have been played back on the music player is logged, and a play list of music tracks, or a list of favorite artists or music groups, is created automatically based on the logged information.

According to a third aspect of the invention there is provided an electronic device and a method for automatically logging information and for displaying the logged information. Information about music tracks that have been received by a radio tuner of the device and music tracks that have been played back on the music player is logged, and the logged information is displayed in a list via the user communication interface. The list of logged information may comprise functionality similar to the functionality of the list of favorite artists or music groups.

These aspects of the invention provide the user with a powerful tool for easily finding and playing his/her favorite music in a sophisticated and entirely automatic manner.

Further characteristics of the invention and advantages thereof will be evident from the following detailed description of embodiments of the invention and the accompanying FIGS. 1-4, which are given by way of illustration only, and thus are not limitative of the present invention.

### BRIEF DESCRIPTION OF THE DRAWINGS

FIG. 1 illustrates, schematically, in a block diagram an electronic device comprising a music player capable of playing back music tracks according to an embodiment of the invention.

FIG. 2 illustrates, schematically, an exemplary embodiment of the electronic device of FIG. 1.

FIGS. 3a and 4a are each a flow chart of a method as performed in the electronic device of FIG. 1 according to a respective embodiment of the present invention.

FIG. 3b gives an example of a list of favorite artists or music groups as being displayed to a user of the electronic device of FIG. 1 when the method illustrated in FIG. 3a is performed.

FIG. 4b gives an example of a list of logging information, which may be displayed to a user of the electronic device of FIG. 1 when the method illustrated in FIG. 4a is performed.

### DETAILED DESCRIPTION OF EMBODIMENTS

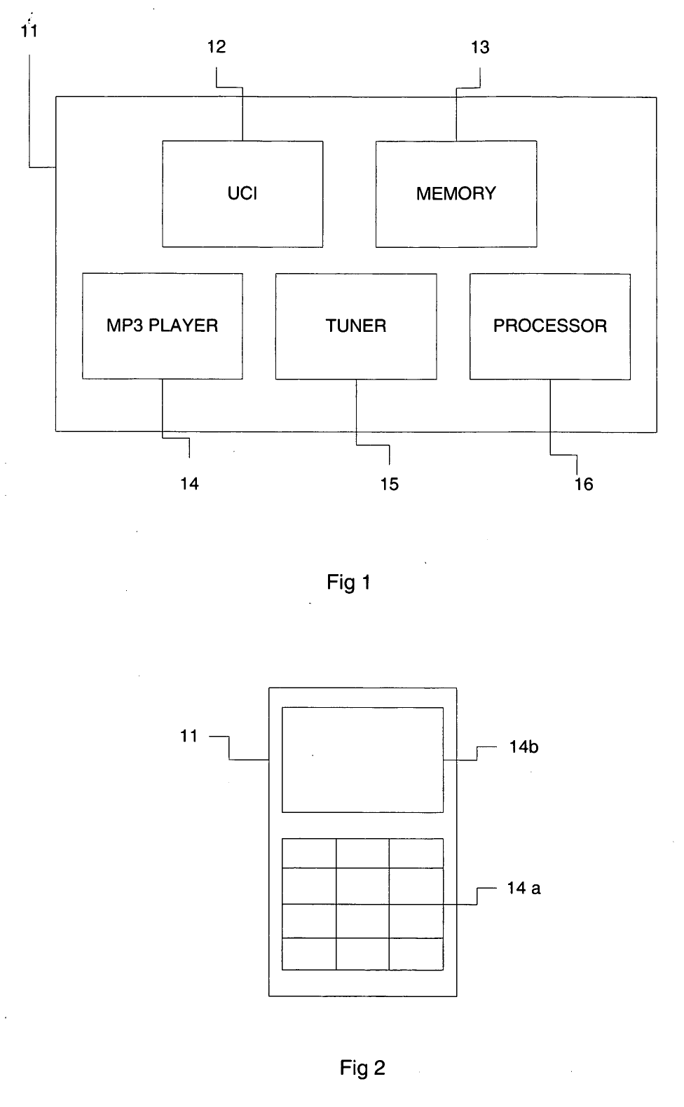

An electronic device 11 according to an embodiment of the invention is illustrated in FIG. 1 and comprises a user communication interface 12, a memory 13, a music player 14, optionally a radio tuner 15, and a processor 16.

The communication interface 12 comprises preferably a keypad or similar, a display unit or screen, and a loudspeaker or a headphone.

The memory 13 is inter alia provided for storing digital music tracks, such as mp3 and wma music tracks, and information about each of the stored music tracks, where the information at least comprises a title of, and a name of an artist or music group on, each of the music tracks.

The music player 14, which is preferably entirely software implemented, is capable of playing back the music tracks stored in the memory. It may also be capable of creating a number of play lists, which is common among prior art music players.

The optional radio tuner 15 is capable of receiving music tracks and other broadcast media content, and information about each of the music tracks from a plurality of radio stations. Preferably, the radio tuner is an RDS or RBDS radio tuner. The information comprises at least a title of, and a name of an artist or music group on, each of the music tracks received by the radio tuner 15.

The processor 16 is provided for receiving commands from a user of the device 11, and for controlling the various components of the device 11.

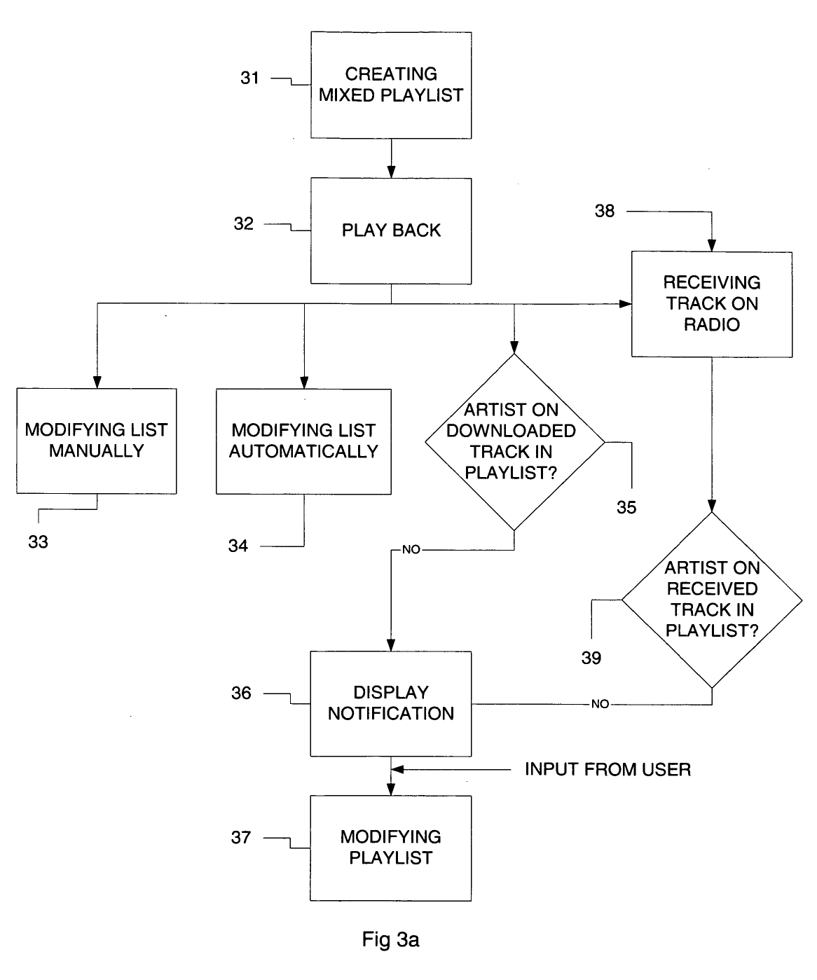

In one embodiment, as being illustrated in FIG. 2, the device 11 is a hand-portable telephone, such as a mobile phone. Such a device may typically comprise a keypad 14a and a joystick or similar for input of commands from the user of the device. Optionally, the phone is provided for receiving voice commands or has a touch sensitive screen. Further, a display unit 14b, a loudspeaker and/or a headphone, and optionally vibration means may be provided for outputting information and alerts to the user.

The device 11 is provided to offer entirely new methods for accessing music tracks and for music listening. The methods, which will be described in the following, are preferably carried out by means of software loadable into the memory 13 of the device 11 and run by the processor 16. The software may be provided on a storage medium such as a DVD, or it may be downloadable from the Internet, e.g. from the Nokia website.

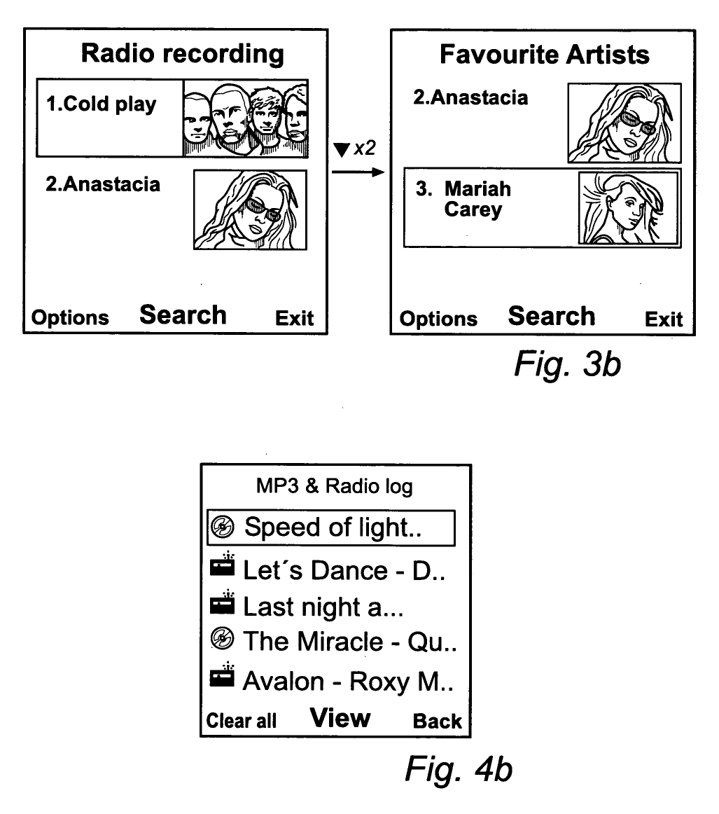

Thus, a method as performed by the electronic device of FIG. 1 according to a first embodiment of the invention will be described with reference to the flow chart of FIG. 3a. The method is referred to as a method for creating a list of favorite artists or music groups and playing back music tracks from the list.

A list of favorite artists or music groups is created in a step 31. The list may be created in a number of different manners. The list of favorite artists or music groups may be created in response to a manual selection from a user of the device 11 via the user communication interface 12. Alternatively, the processor 16 may be provided for creating the list of favorite artists or music groups automatically based on logged information regarding artists or music groups of music tracks that have been played back on the music player 14. Still alternatively, the list of favorite artists or music groups is created automatically based on logged information regarding artists or music groups of music tracks that have been received by the radio tuner 15. Yet alternatively, the list of favorite artists or music groups may be created according to any combination of the above methods depending on user settings.

Similarly, the favorite artists or music groups in the list of favorite artists or music groups may be ordered in a selected prioritized order. Such ordering may be performed manually or automatically, e.g. based on the logged information.

Next, the music player 14 is controlled, in a step 32, to play back a music track stored in the memory 13 in response to a request from a user of the device 11 via the user communication interface 12, wherein the played back music track is performed by one of the favorite artists or music groups in the list of favorite artists or music groups.

An example of a list of favorite artists or music groups called “Favourite Artists” is illustrated on the left-hand side of FIG. 3b. The list comprises a list number, the name of the artist or music group, and a picture of the artist or music group. The list may be displayed automatically at desired instants and/or manually in response to a request from the user of the device 11. The user may typically be capable of scrolling through the list since many electronic devices have rather small display units. In the example of FIG. 3b only two entries of the list are shown at a time. In the list shown on the right-hand side of FIG. 3b a user has scrolled down to artist or music group No. 3. The entries may be selectable, one or several at a time, by clicking (or selecting in other manner) the respective entry/entries (i) to obtain further information of the selected artist(s) or music group(s), (ii) to control the music player 14 to start playing back stored music tracks of the selected artist(s) or music group(s), and/or (iii) to display a list of titles of the stored music tracks of the selected artist(s) or music group(s) depending on the options available and the user settings. In the latter case the music track titles may be selectable, one or several at a time, by clicking (or selecting in other manner) the respective title(s) to start playing back the selected music tracks.

Further, the list of favorite artists or music groups of FIG. 3b is accompanied by three selection keys or buttons “Options”, “Search”, and “Exit”. The selection keys or buttons allow the user to select different options, to search for artists or music groups in the list of favorite artists or music groups, and to exit from the list.

The present invention further provides the user with a number of options for modifying and deleting the list of favorite artists or music groups.

Again with reference to the flow chart of FIG. 3a, the user may modify or delete the list of favorite artists or music groups manually in a step 33. For instance the options in the example of FIG. 3b may comprise the option of deleting a highlighted artist or music group in the list of favorite artists or music groups and the option of adding a further artist or music group to the list.

Additionally, or alternatively, the list of favorite artists or music groups may be adjusted (or deleted) entirely automatically in a step 34, e.g. based on logged information regarding the user's music listening pattern.

Further, two semi-automatic methods of adding an artist or music group to the list of favorite artists or music groups may be provided, each as an alternative, or as a further option, to the above manual and fully automatic approaches.

According to a first one of these methods, it is checked, in a step 35, in connection with the downloading of a music track of a particular artist or music group, whether this particular artist or music group is comprised in the list of favorite artists or music groups, and if the particular artist or music group is not comprised in the list of favorite artists or music groups, a notification of the name of the particular artist or music group of the music track is displayed to the user via the user communication interface 12 in a step 36. The notification is accompanied by input means for the user to select to add, in a step 37, the particular artist or music group of the music track to the list of favorite artists or music groups. Depending on user settings the above steps may instead, or as well, be performed when a music track stored in the memory 13 is played back on the music player 14.

According to a second one of these methods, it is checked, in a step 39, in connection with the receiving of a music track of a particular artist or music group by the optional radio tuner 38, whether this particular artist or music group is comprised in the list of favorite artists or music groups, and if the particular artist or music group is not comprised in the list of favorite artists or music groups, a notification is displayed in accordance with step 36, and the user may select to add the particular artist or music group to the list of favorite artists or music groups in accordance with step 37.

It shall be appreciated that the concept of the invention may be extended to enable the user to manually or automatically create multiple lists of favorite artists or music groups. The lists may be based on various criteria. For instance, different lists of favorite artists or music groups may comprise artists or music groups that perform music tracks in different genres, different lists of favorite artists or music groups may have different priorities, or different lists of favorite artists or music groups may comprise different kinds of artists or music groups, e.g. artists or music groups singing in different languages, or one list may comprise favorite female singers, another list may comprise favorite male singers, and yet another list may comprise favorite music groups.

The lists of favorite artists or music groups may be used in the generation of play lists. For instance, a play list may be generated as all music tracks of a set of artists or music groups stored in the memory, wherein the set of artists or music groups is selected from the list of favorite artists or music groups. The user may then select to listen to the music tracks of the play list.

The above embodiment thus provides for the creation of a list of favorite artists or music groups, which list may be used for playing back music tracks of the favorite artists or music groups, for searching for music tracks of those artists or music groups, and for creating play lists of music tracks of those artists or music groups. The embodiment provides for various approaches of creating and updating the list. A powerful tool for managing music tracks is provided, particularly for those having a large number of music tracks stored in their devices.

The embodiment may be implemented as a separate application in the device, or it may be implemented as an integral part of the music player and/or of the radio tuner of the device. If integrated in the music player, the user may chose to start playing back music tracks from the list of favorite artists or music groups automatically when the music player is switched on.

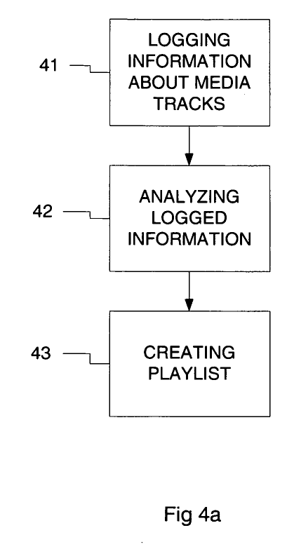

Next, with reference to the flow chart of FIG. 4a, a method as performed by the electronic device 11 of FIG. 1 according to a second embodiment of the invention will be described. This method is referred to as a method for logging information regarding a user's music listening pattern, and using this information for creating a play list of music tracks, or a list of favorite artists or music groups in accordance with the above. The present embodiment requires that the electronic device 11 is equipped with both the music player 14 and the radio tuner 15, that the music tracks stored in the memory 13 contains titles of the music tracks, and names of artists or music groups on the music tracks, and that titles of the music tracks, and names of artists or music groups on the music tracks, which are received by the radio tuner 15, are also received.

While the user listens to music tracks played back on the music player and music tracks received by the radio tuner, information about the music tracks is logged, in a step 41, independently of whether the music tracks have been played back on the music player 14, or have been received by the radio tuner 15.

The logged information is then advantageously processed and analyzed in a step 42, and a play list of music tracks, or a list of favorite artists or music groups, is created automatically, in a step 43, based on the logged information, preferably after processing and analyzing. The processing and analyzing is performed to retrieve the user's music listening pattern, and the creating of a play list or favorite artist or music group list is performed according to this pattern.

In case a list of e.g. top five favorite artists and music groups is created, one or several play lists may be defined based on music tracks of the artists or music groups comprised in such a list.

An example of a list of logging information called “MP3 & Radio log” as displayed to the user of the device 11 is illustrated in FIG. 4b. The list comprises for each entry a symbol indicating whether the music track has been played back on the music player 14 (a disc) or whether it has been received by the radio tuner 15 (a radio), the title of the music track, and the name of the artist or music group on the music track.

Further, the “MP3 & Radio log” is accompanied by three selection keys or buttons “Clear all”, “View”, and “Back”. The selection keys or buttons allow the user to select to delete the logged information, to view further information of an entry (if there is any further information), or to remove the displayed list of logging information.

The further information may comprise, for each music track played back and for each music track received, a day and time, at which the music track was received/played back. For broadcast music the name of the radio station is also logged.

By means of displaying the logged information, the user can obtain useful information about his/her music listening behavior: when does the user listen to different kind of music, how much does the user listen to different kind of music, how is the music listening pattern altered with time, etc. The information may be displayed graphically.

From the list of logged information, the user may choose to play a specified music track, to play another music track from a specified artist or music group, and to create play lists.

If a play list contains a music track that is neither stored in the memory nor available on a radio channel at the time the user is to listen to it, it may simply be skipped. Further, if it is checked and detected that a music track, which exists in a play list in use but is not stored in the memory 13, is being, or is in the near future to be, broadcast from a radio station the device may suggest to switch on the radio tuner, if not already being switched on, and tune to the radio station to listen to the music track directly despite the fact that it was scheduled to be played at a later time.

Further, the logged information may only comprise information about music tracks that have been played back on the music player 14 in its entirety and music tracks that have been received by the radio tuner 15 in its entirety, or at least information about music tracks that have been received/played back at least during a given period of time before being skipped. Alternatively, the music tracks which are listened to in their entirety may be given a higher priority, and the music tracks which are listened to for a short time only may be given a lower priority.

During the analysis of the logged information the mostly received/played music tracks and/or the mostly received/played artists or music groups may be identified, and a play list of music tracks may be created automatically, wherein the music tracks are the mostly received/played music tracks and/or music tracks of the mostly received/played artists or music groups. Alternatively, a list of favorite artists or music groups is created, wherein the favorite artists or music groups are the mostly received/played artists or music groups.

Further, the logged information may be analyzed to find received/played back music tracks that have been received/played back during a particular time interval, and a play list of music tracks, or a list of favorite artists or music groups, may be created automatically based on information regarding music tracks that have been received/played back during that particular time interval. Such list may also be displayed to the user only during such time interval. For instance, if a user listens to artists playing pop or soft rock in the mornings, and to artists playing dance music on Friday and Saturday evenings, such pattern would affect the lists created so that one play list of pop or soft rock music tracks (or one list of artists or music groups playing pop or soft rock) and one play list of dance music tracks (or one list of artists or music groups playing dance music) are formed, wherein the lists may be displayed or may be selectable only during the respective times (mornings and Friday and Saturday evenings, respectively).

Yet alternatively, if the information stored in the memory comprises, for each of the played back music tracks, the name of the music album and/or of the music genre, to which the music track belongs, the logged information may comprise, for each of the music tracks played back, the name of the music album and/or of the music genre, to which the music track belongs. Additionally, or alternatively, if the information received by the radio tuner comprises, for each of the received music tracks, the name of the music album or of the music genre, to which the music track belongs (provided that the radio system supports the communication of such information), the logged information may comprise, for each of the music tracks received, the name of the music album or of the music genre, to which the music track belongs. Hereby, the lists may not only comprise music tracks of particular artists or music groups, but also music tracks of particular music albums and/or music tracks of particular music genres.

From the list of logged information, e.g. from the one illustrated in FIG. 4b, a user may be capable of choosing to play a music track of a specified genre or from a specified album.

A radio channel to listen to may be proposed automatically based on the logged information, e.g. based on previous radio channel listening patterns.

In the list of logged information the user may select one entry and then choose to see which radio channels are currently playing music of (i) the same artist, or (ii) of the same genre as the artist and genre associated with the entry.

By means of this embodiment the user is able to easily search for recently played music tracks by displaying the list of logged information. The device 11 is capable of not only showing played back music tracks on the music player 14, but is also capable of showing music tracks listened to on the radio—preferably integrally with the music tracks played back on the music player 14. The user does not have to worry about which media to use to get his/her favorite music played since the sophisticated lists displayed to the user contains information both from the music player and from the radio.

The user is thus provided with a powerful tool for easily finding and playing his/her favorite music in a sophisticated and automatic manner by letting the device itself search for music and select proper application to play the music.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. An electronic device comprising:
a user communication interface;
a memory for storing music tracks and information about each of the stored music tracks, said information comprising titles of the music tracks and names of artists or music groups on the music tracks;
a music player capable of playing back the music tracks; and
a processor provided for creating a list of favorite artists or music groups and controlling the music player to play back music tracks stored in the memory, one after the other, in response to a request from a user of the device via the user communication interface, wherein said played back music tracks are performed by one, several or all of the favorite artists or music groups in the list of favorite artists or music groups.

2. The device of claim 1 wherein said processor is provided for creating the list of favorite artists or music groups in response to a manual selection from a user of the device via the user communication interface.

3. The device of claim 1 wherein said processor is provided for creating the list of favorite artists or music groups automatically based on logged information regarding artists or music groups of music tracks that have been played back on said music player.

4. The device of claim 1 wherein said processor is provided, in connection with the downloading of a music track of a particular artist or music group that is not comprised in the list of favorite artists or music groups, for providing a notification of the name of the particular artist or music group of the music track to the user via said user communication interface, said notification being accompanied by input means for the user to select to add the particular artist or music group of the music track to the list of favorite artists or music groups.

5. The device of claim 1 wherein said device comprises a radio tuner capable of receiving music tracks and names of artists or music groups on the music tracks from a plurality of radio stations, and said processor is provided for creating the list of favorite artists or music groups automatically based on logged information regarding artists or music groups of music tracks that have been received by said radio tuner.

6. The device of claim 1 wherein said device comprises a radio tuner capable of receiving music tracks and names of artists or music groups on the music tracks from a plurality of radio stations, and said processor is provided, in connection with the receiving of a music track of a particular artist or music group that is not comprised in the list of favorite artists or music groups by the radio tuner, for providing a notification of the name of the particular artist or music group of the music track to the user via said user communication interface, said notification being accompanied by input means for the user to select to add the particular artist or music group of the music track to the list of favorite artists or music groups.

7. The device of claim 1 wherein said processor is provided for
searching for music tracks stored in the memory that are performed by an artist or music group comprised in the list of favorite artists or music groups in response to a request from a user of the device via the user communication interface; and
alerting a user of the device via said user communication interface about the result of said search.

8. The device of claim 1 wherein said processor is provided for
generating a play list of all music tracks of a set of artists or music groups stored in the memory, the set of artists or music groups being selected from the list of favorite artists or music groups; and
controlling the music player to play back music tracks of said play list of music tracks in response to a request from a user of the device via the user communication interface.

9. The device of claim 8 wherein said set of artists or music groups are selected as one, several, or all of the artists or music groups of the list of favorite artists or music groups.

10. The device of claim 8 wherein said processor is provided for creating the play list in response to a manual selection from a user of the device via the user communication interface.

11. The device of claim 8 wherein said processor is provided for creating the play list automatically based on information stored in the memory.

12. The device of claim 1 wherein said processor is provided for ordering the favorite artists or music groups in the list of favorite artists or music groups in a selected order.

13. The device of claim 1 wherein said electronic device is a hand-portable telephone.

14. A method for playing back music tracks in an electronic device comprising a user communication interface, a memory for storing music tracks and information about each of the stored music tracks, a music player capable of playing back the music tracks, and a processor, wherein information comprises titles of the music tracks and names of artists or music groups on the music tracks, said method comprising:
creating a list of favorite artists or music groups; and
playing back music tracks stored in the memory one after the other in response to a request from a user of the device via the user communication interface, wherein
said played back music tracks are performed by one, several or all of the favorite artists or music groups in the list of favorite artists or music groups.

15. An electronic device comprising:
a user communication interface;
a memory for storing music tracks and information about each of the stored music tracks, said information comprising titles of the music tracks and names of artists or music groups on the music tracks;
a music player capable of playing back the music tracks stored in the memory; and
a processor provided for
logging the information about music tracks that have been received by the radio tuner and about music tracks that have been played back on said music player; and
creating a play list of music tracks or a list of favorite artists or music groups automatically based on said logged information.

16. The device of claim 15 wherein said processor is provided for
analyzing the logged information to find the mostly received/played music tracks and/or the mostly received/played artists or music groups; and
creating a play list of music tracks automatically, wherein said music tracks are the mostly received/played music tracks and/or music tracks of the mostly received/played artists or music groups.

17. The device of claim 15 wherein said processor is provided for
analyzing the logged information to find the mostly received/played music tracks and/or the mostly received/played artists or music groups; and
creating list of favorite artists or music groups, wherein the favorite artists or music groups are the mostly received/played artists or music groups.

18. The device of claim 15 wherein
said information stored in the memory comprises, for each of the played back music tracks, the name of the music album and/or of the music genre, to which the music track belongs; and
the logged information comprises, for each of the music tracks played back, the name of the music album and/or of the music genre, to which the music track belongs.

19. The device of claim 15 wherein
said information received by the radio tuner comprises, for each of the received music tracks, the name of the music album or of the music genre, to which the music track belongs; and
the logged information comprises, for each of the music tracks received, the name of the music album or of the music genre, to which the music track belongs.

20. The device of claim 15 wherein the logged information comprises, for each music track received and for each music track played back, a day and time, at which the music track was received/played back.

21. The device of claim 20 wherein said processor is provided for
analyzing the logged information to find received/played music tracks that have been received/played during a particular time interval; and
creating a play list of music tracks or a list of favorite artists or music groups automatically based on information regarding music tracks that have been received/played during a particular time interval.

22. The device of claim 15 wherein the logged information only comprises information about music tracks that have been received by the radio tuner in its entirety and music tracks that have been played back on said music player in its entirety.

23. The device of claim 15 wherein the logged information only comprises information about music tracks that have been received by the radio tuner at least during a given period of time and music tracks that have been played back on said music player at least during a given period of time.

24. A method in an electronic device comprising a user communication interface, a radio tuner a radio tuner capable of receiving music tracks and information about each of the music tracks from a plurality of radio stations, a memory for storing music tracks and information about each of the stored music tracks, a music player capable of playing back the music tracks stored in the memory, and a processor, wherein said information capable of being received by the radio tuner comprises titles of received music tracks, and names of artists or music groups on the received music tracks, and said information stored in the memory comprises titles of the music tracks stored in the memory and names of artists or music groups on the music tracks stored in the memory, said method comprising the steps of:
logging the information about music tracks that have been received by the radio tuner and music tracks that have been played back on said music player; and
creating a play list of music tracks, or a list of favorite artists or music groups, automatically based on said logged information.

25. An electronic device comprising:
a user communication interface;
a radio tuner capable of receiving music tracks and information about each of the music tracks from a plurality of radio stations, said information comprising titles of the music tracks, and names of artists or music groups on the music tracks;
a memory for storing music tracks and information about each of the stored music tracks, said information comprising titles of the music tracks and names of artists or music groups on the music tracks;
a music player capable of playing back the music tracks stored in the memory; and
a processor provided for
logging the information about music tracks that have been received by the radio tuner and about music tracks that have been played back on said music player; and
displaying said logged information in a list via said user communication interface.

26. A method in an electronic device comprising a user communication interface, a radio tuner a radio tuner capable of receiving music tracks and information about each of the music tracks from a plurality of radio stations, a memory for storing music tracks and information about each of the stored music tracks, a music player capable of playing back the music tracks stored in the memory, and a processor, wherein said information capable of being received by the radio tuner comprises titles of received music tracks, and names of artists or music groups on the received music tracks, and said information stored in the memory comprises titles of the music tracks stored in the memory and names of artists or music groups on the music tracks stored in the memory, said method comprising:
logging the information about music tracks that have been received by the radio tuner and music tracks that have been played back on said music player; and
displaying said logged information in a list via said user communication interface.
